(19) United States
(12) Patent Application Publication
(10) Pub. No.: US 2008/0174249 A1
(43) Pub. Date: Jul. 24, 2008

(54) Plasma display apparatus

(76) Inventor: Yoo-jin Song, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/000,506

(22) Filed: Dec. 13, 2007

(30) Foreign Application Priority Data
Jan. 24, 2007 (KR) 10-2007-0007601

(51) Int. Cl. G09G 3/10; H01H 61/00

(52) U.S. Cl. 315/169.4; 337/14

(57) ABSTRACT

A plasma display apparatus includes a selection circuit having a first terminal and a second terminal, a pulse supply unit having a first power source configured to provide a first voltage to the first terminal of the selection circuit, a second power source configured to provide a second voltage to the second terminal of the selection circuit, and a thermal fusible resistor between the first terminal of the selection circuit and the first power source, wherein the selection circuit is configured to selectively provide a first voltage and a second voltage to an electrode of the plasma display apparatus.

### BACKGROUND OF THE INVENTION

1. Field of the Invention

Embodiments relate to a plasma display apparatus and, more particularly, to a plasma display apparatus that may exhibit an improved reliability and/or may have fewer components with respect to plasma display apparatuses in the related art.

2. Description of the Related Art

In general, a plasma display panel may include a scan electrode and a sustain electrode on an upper substrate of the plasma display panel. Additionally, a plasma display panel may include an address electrode on a lower substrate of the plasma display panel to intersect the scan electrode and the sustain electrode. The lower substrate may face the upper substrate.

In the plasma display panel described above, a frame of the plasma display panel may be divided into a plurality of sub-fields, the plurality of sub-fields each having a predetermined weight to be driven. The sub-fields may be divided into a reset period, an address period and a sustain period, for example.

During the reset period, a ramp pulse may be supplied to the scan electrode to generate a predetermined wall charge so that a next address discharge may occur. During the address period, a scan pulse may be sequentially supplied to the scan electrode, and a data pulse may be supplied to the address electrode. Accordingly, an address discharge occurs in a discharge cell to which the data pulse is supplied, thereby generating the predetermined wall charge.

During the sustain period, a sustain pulse may be alternately supplied to the scan electrode and the sustain electrode to cause a sustain discharge in a cell selected by the address discharge. This may result in images of predetermined luminance being displayed on a panel in accordance with the number of the sustain discharges.

A scan driver may supply a predetermined drive wave (also referred to as a drive voltage) to the scan electrode. The sustain electrode may be coupled to a sustain driver. The scan driver may include a selection circuit and a pulse supply unit. The selection circuit may be coupled to one or more scan electrodes. The pulse supply unit may supply a scan pulse.

The selection circuit may selectively provide a voltage provided via a first node and/or a second node to the one or more scan electrodes. For example, the selection circuit may control a drive wave supplied to the scan electrodes while controlling the on/off characteristics of one or more transistors.

The pulse supply unit may supply a scan pulse to the one or more scan electrodes during an address period. In this example, the pulse supply unit may include a current controller, a second resistor, a second diode, a transistor and a capacitor. The current controller may be coupled to the first node. The second resistor and the second diode may be coupled between a first power supply and the current controller. The transistor may be coupled between a second power supply and a second node. The capacitor may be coupled between the second diode and the second node.

The first power supply may supply a voltage of the first power supply to the first node. The second diode may prevent a reverse current from flowing.

The second power supply may supply a voltage of the second power supply to the second node. In this example, if a scan pulse is supplied during the address period, the transistor of the selection circuit may be turned on. Alternatively, if the scan pulse is not supplied, the transistor of the selection circuit may not be turned on.

During the address period, the transistor may be turned on to supply a voltage of the second power supply to the second node. The capacitor may maintain a difference between a voltage of the first node and a voltage of the second node.

The current controller may prevent a peak current from flowing during operation of the scan driver. In this example, the current controller may include a first resistor and a first diode, which may be connected between a second diode and the first node in parallel. The first resistor may be arranged along a flow path of an electric current, and may prevent a peak current from flowing. The first diode may be configured to turn on if an electric current flows from the first node to a common node of the second diode and the capacitor.

In the conventional scan driver described above, because the first resistor is disposed in a flow path of the electric current, a high heat may be generated. Moreover, because the electric current flows from the first node to the common node of the second diode, and the capacitor current does not flow only to the first diode, a significant heat may be generated in the first resistor. This may, in some circumstances, result in a risk of an ignition due to a heat generation in the first resistor.

In order to reduce or prevent a risk of ignition, a plurality of 3W grade resistors, for example, 8 through 10 resistors may be arranged in parallel as the first resistor. If the plurality of resistors are arranged in parallel as the first resistor, a heat generation problem may be reduced. However, a peak current flowing to the selection circuit may be increased, which may result in deterioration of reliability of the plasma display panel.

### SUMMARY OF THE INVENTION

Embodiments are therefore directed to a plasma display apparatus that may address one or more of the disadvantages of the related art.

It is therefore a feature of an embodiment of the present invention to provide a plasma display apparatus employing a thermal fusible resistor.

At least one of the above and other features of the present invention may be realized by providing a plasma display apparatus including a selection circuit having a first terminal and a second terminal, and a pulse supply unit having a first power source configured to provide a first voltage to the first terminal of the selection circuit, a second power source configured to provide a second voltage to the second terminal of the selection circuit, and a thermal fusible resistor between the first terminal of the selection circuit and the first power source, wherein the selection circuit is configured to selectively provide a first voltage and a second voltage to an electrode of the plasma display apparatus.

The thermal fusible resistor may include a resistor and a temperature fuse configured to cut off a flow of an electric current according to a temperature of the resistor.

The pulse supply unit may further include a diode between the thermal fusible resistor and the first power source, a transistor between the second power source and the second terminal of the selection circuit, and a capacitor between a common terminal of the thermal fusible resistor and the diode and the second terminal of the selection circuit.

The pulse supply unit may further include a resistor between the diode and the first power source. The electrode may include a scan electrode or a sustain electrode. The first voltage and the second voltage may include a scan pulse. The temperature fuse may be configured to cut off a flow of an electric current if a temperature of the resistor exceeds about 104° C.

At least one other of the above and other features of the present invention may be realized by providing a plasma display apparatus including a plasma display panel having a plurality of scan electrodes, sustain electrodes and address electrodes, a selection circuit having a first terminal and a second terminal, a pulse supply unit having a first power source configured to provide a first voltage to the first terminal of the selection circuit, a second power source configured to provide a second voltage to the second terminal of the selection circuit, and a thermal fusible resistor between the first terminal of the selection circuit and the first power source, and a power supply configured to provide power to the pulse supply unit, wherein the selection circuit is configured to selectively provide a first voltage and a second voltage to one or more of the scan electrodes of the plasma display panel.

The plasma display apparatus may further include a scan driver coupled to the plurality of scan electrodes, an address driver coupled to the plurality of address electrodes, and a sustain driver coupled to the plurality of sustain electrodes.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a portion of a plasma display apparatus according to an embodiment of the present invention;

FIG. 2 illustrates a drive wave that may be supplied to the portion of a plasma display apparatus illustrated in FIG. 1;

FIG. 3 illustrates a schematic diagram of a selection circuit and pulse supply unit that may be employed in a plasma display apparatus according to an embodiment of the present invention; and

FIG. 4 illustrates a schematic diagram of a thermal fusible resistor that may be employed in a plasma display apparatus according to an embodiment of the present invention.

### DETAILED DESCRIPTION OF THE INVENTION

Korean Patent Application No. 10-2007-0007601, filed on Jan. 24, 2007, in the Korean Intellectual Property Office, and entitled, “Plasma Display Panel,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the accompanying drawings, dimensions may be exaggerated for clarity of illustration. Furthermore, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present invention. As used herein, the term “and/or” includes any and all combinations of one or more of the associated listed items.

Additionally, it will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” and the like).

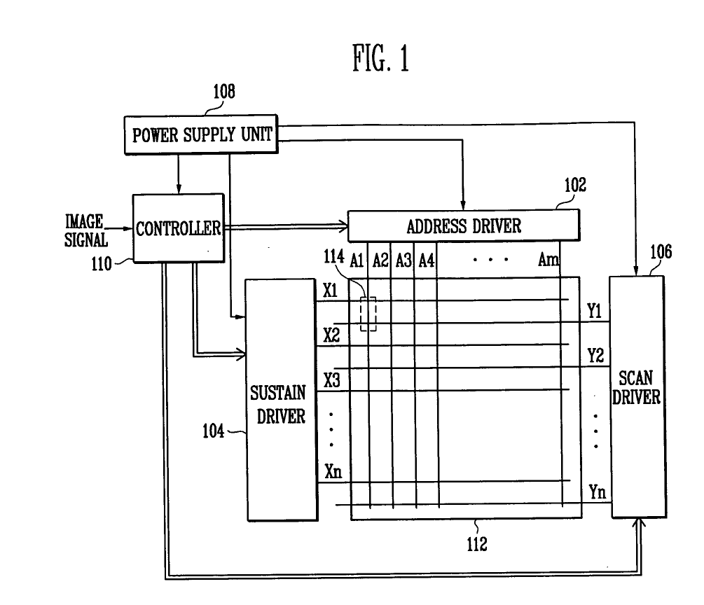

FIG. 1 illustrates a portion of a plasma display apparatus according to an embodiment of the present invention. As shown in FIG. 1, the portion of plasma display apparatus includes a plasma display panel 112, an address driver 102, a sustain driver 104, a scan driver 106, a power supply unit 108, and a controller 110.

The plasma display panel 112 includes scan electrodes Y1 to Yn, sustain electrodes X1 to Xn, and address electrodes A1 to Am. The scan electrodes Y1 to Yn and the sustain electrodes X1 to Xn may be approximately parallel with respect to one another. The address electrodes A1 to Am may be approximately perpendicular with respect to scan electrodes Y1 to Yn and the sustain electrodes X1 to Xn, and may be formed to intersect scan electrodes Y1 to Yn and sustain electrodes X1 to Xn. One or more discharge cells 114 may be disposed at intersections of the scan electrodes Y1 to Yn and the sustain electrodes X1 to Xn with the address electrodes A1 to Am. However, it is worthwhile to note that embodiments of the present invention are not limited to the above-described configuration.

In operation, the controller 110 may receive an external image signal and may generate control signals to control the address driver 102, the sustain driver 104, and the scan driver 106. In this example, the controller 110 may generate the control signals such that one frame of the control signal may be divided into a plurality of sub-frames, and may include fields having a reset period, an address period, and a sustain period to be driven.

The address driver 102 may supply a data pulse to the address electrodes A1 to Am during an address period of each sub-field according to a control signal from the controller 110, to select discharge cells 114 to be turned on.

The sustain driver 104 may supply a sustain pulse to the sustain electrodes X1 to Xn during a sustain period of each sub-field according to the control signal from the controller 110.

The scan driver 106 may control a drive wave to be supplied to the scan electrodes Y1 to Yn according to the control signal from the controller 110. For example, the scan driver 106 may supply a ramp pulse to the scan electrodes Y1 to Yn during a reset period of each sub-field and may sequentially supply a scan pulse thereto during an address period of each sub-field. Furthermore, the scan driver 106 may alternately supply a sustain pulse to the sustain electrodes X1 to Xn during the sustain period of each sub-field.

The power supply unit 108 may supply a power source to the controller 110 and the drivers 102, 104, and 106 to drive the plasma display panel 112.

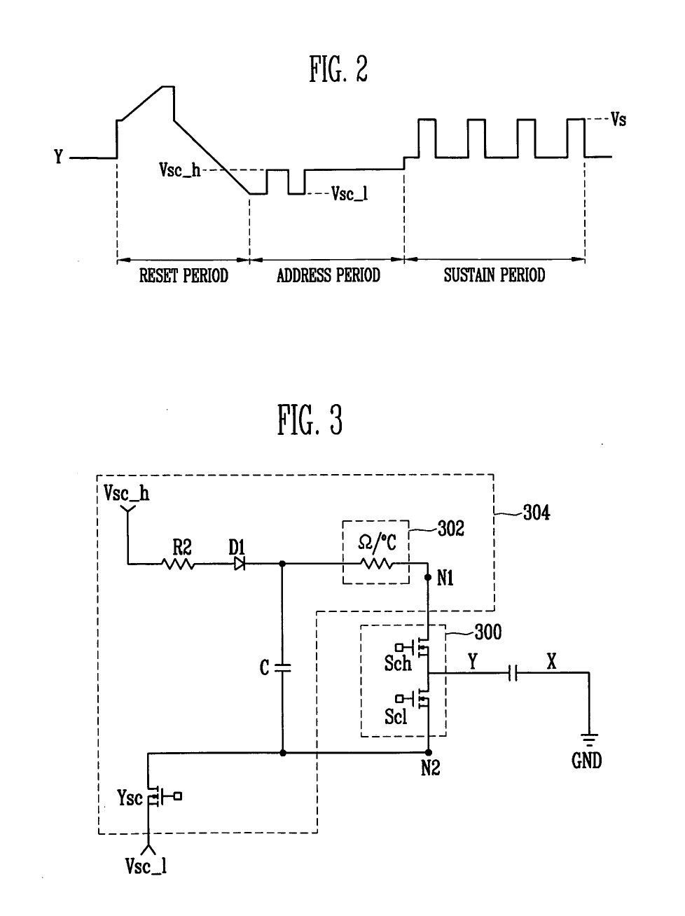

FIG. 2 illustrates a drive wave, which may be supplied to the scan driver of the plasma display apparatus as illustrated in FIG. 1, in accordance with an embodiment. As illustrated in FIG. 2, the scan driver 106 (see FIG. 1) may supply a ramp-up pulse and a ramp-down pulse to a scan electrode Y (see FIG. 1) during the reset period. If the ramp-up pulse is supplied, a plurality of fine discharges may occur in a discharge cell 114 (see FIG. 1) to generate predetermined wall charges. If the ramp-down pulse is supplied, a portion of one or more wall charges generated in the discharge cell 114 in accordance with the ramp-up pulse may be discharged. If a partial wall charge generated in the discharge cell 114 in accordance with the ramp-down pulse is discharged, it may prevent a strong discharge from occurring in the discharge cell 114 during the address period.

During the address period, the scan driver 106 may sequentially supply a scan pulse to the scan electrodes Y. In this example, the address driver 102 (see FIG. 1) may supply a data pulse to the address electrodes A1 to Am in accordance with a gradation to be displayed. Accordingly, a wall charge generated during the reset period may be added to a voltage difference between the scan pulse and the data pulse to cause an address discharge in a discharge cell to which the data pulse is supplied. A wall charge that may enable a sustain discharge may be generated in the discharge cell 114 in which the address discharge is generated.

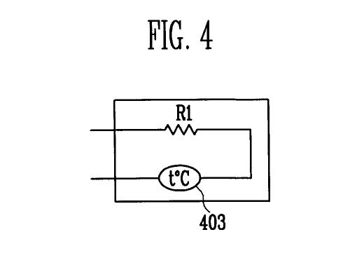

Alternatively, during the address period, the scan driver 106 may supply a voltage of the second power source Vsc_1 illustrated in FIG. 3 to a scan electrode (for example, Y1) to which the scan pulse is supplied, and may supply a voltage of the first power source Vsc_h to remaining scan electrodes Y2 to Yn. However, this will be explained in greater detail with reference to FIG. 3, later.

During the sustain period, the scan driver 106 may supply a sustain pulse to the scan electrode Y. In this example, the sustain driver 104 (see FIG. 1) may supply a sustain pulse to a sustain electrode X, alternately with a sustain pulse supplied to the scan electrode Y. Accordingly, a voltage of a sustain pulse may be added to a wall charge in the discharge cell 114 selected by an address discharge to cause sustain discharges. In this example, the number of the sustain discharges may depend at least in part on the number of the sustain pulses.

FIG. 3 illustrates a schematic diagram of a scan driver, such as scan driver 106 of FIG. 1, in accordance with an embodiment. As illustrated in FIG. 3, an arrangement of various components of the scan driver may be configured to supply a scan pulse. The sustain electrode X may be coupled to a sustain driver (not shown). However, for convenience of a description, the sustain electrode X is illustrated as being coupled to a ground voltage source GND, but it is worthwhile to note that the scope of the subject matter is not so limited.

The scan driver illustrated in FIG. 3 includes a selection circuit 300 and a pulse supply unit 304. The selection circuit 300 is coupled to one or more scan electrodes Y. The pulse supply unit 304 may supply a scan pulse. The selection circuit 300 may selectively control a voltage provided from a first node N1 (or first terminal) or a second node N2 (or second terminal) of the pulse supply unit 304. For example, the selection circuit 300 may control a drive wave (drive voltage) provided from a first node N1 (or first terminal) or a second node N2 (or second terminal) of the pulse supply unit 304 and selectively apply the drive wave to scan electrodes Y, by controlling on/off characteristics of transistors Sch and Sc1.

The pulse supply unit 304 may supply a scan pulse to the scan electrodes Y during an address period. The pulse supply unit 304 may include a current controller 302, a second resistor R2, a diode D1, a transistor Ysc, and a capacitor C. The current controller 302 may be coupled to the first node N1. The second resistor R2 and the diode D1 may be coupled between a first power source Vsc_h and the current controller 302. The transistor Ysc may be coupled between a second power source Vsc_1 and a second node N2. The capacitor C may be coupled between a common terminal of the diode D1 and the current controller 302, and the second node N2.

The first power source Vsc_h may supply a voltage (or first voltage) of the first power source Vsc_h to the first node N1. A transistor (not shown) may be coupled between the first power source Vsc_h and the first node N1, and may be turned on during the address period, for example. The diode D1 may prevent a reverse current from flowing. The second resistor R2 is disposed between the diode D1 and the first power source Vsc_h, but may be omitted in alternative embodiments.

The second power source Vsc_1 may supply a voltage (or second voltage) of the second power source Vsc_1 to the second node N2. In this example, if a scan pulse is supplied during the address period, the transistor Sc1 of the selection circuit 300 may be turned on. Alternatively, if the scan pulse is not supplied, the transistor Sch of the selection circuit 300 may not be turned on.

During the address period, the transistor Vsc may be turned on to supply a voltage of the second power source Vsc_1 to the second node N2. The capacitor C may maintain a difference between a voltage of the first node N1 and a voltage of the second node N2. In one example, the capacitor C may stably (e.g. within a particular voltage range) maintain a difference between a voltage of the first node N1 and a voltage of the second node N2.

The current controller 302 may prevent a peak current from flowing during a driving of the scan driver by employing a thermal fusible resistor. The thermal fusible resistor may be arranged in a flow path of an electric current, and may prevent a peak current from flowing. Referring to FIG. 4, the thermal fusible resistor includes a first resistor R1 and a temperature fuse 403. The thermal fusible resistor illustrated in FIG. 4 may be employed as a thermal fusible resistor in the scan driver of FIG. 3. The first resistor R1 may be employed to prevent a peak current from flowing. In operation, the temperature fuse 403 may sense a temperature of the first resistor R1, and may cut off a flow of an electric current if the sensed temperature of the first resistor R1 exceeds a predetermined value (e.g., a temperature of about 104° C.).

As is clear from the foregoing description, the plasma display apparatus may reduce or prevent the occurrence of a peak current using a thermal fusible resistor. Furthermore, if a high heat is generated, the thermal fusible resistor may be configured to cut off a flow of an electric current, which may reduce a likelihood of ignition and may result in a more stable plasma display apparatus. Moreover, because the plasma display apparatus described herein employs a thermal fusible resistor, the number of components may be reduced, resulting in a decreased cost or complexity.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display apparatus, comprising:
a selection circuit comprising a first terminal and a second terminal; and
a pulse supply unit comprising a first power source configured to provide a first voltage to the first terminal of the selection circuit, a second power source configured to provide a second voltage to the second terminal of the selection circuit, and a thermal fusible resistor between the first terminal of the selection circuit and the first power source,
wherein the selection circuit is configured to selectively provide a first voltage and a second voltage to an electrode of the plasma display apparatus.

2. The plasma display apparatus as claimed in claim 1, wherein the thermal fusible resistor comprises:
a resistor; and
a temperature fuse configured to cut off a flow of an electric current according to a temperature of the resistor.

3. The plasma display apparatus as claimed in claim 1, wherein the pulse supply unit further comprises:
a diode between the thermal fusible resistor and the first power source;
a transistor between the second power source and the second terminal of the selection circuit; and
a capacitor between a common terminal of the thermal fusible resistor and the diode and the second terminal of the selection circuit.

4. The plasma display apparatus as claimed in claim 3, wherein the pulse supply unit further comprises a resistor between the diode and the first power source.

5. The plasma display apparatus as claimed in claim 1, wherein the electrode comprises a scan electrode.

6. The plasma display apparatus as claimed in claim 5, wherein the first voltage and the second voltage comprise a scan pulse.

7. The plasma display apparatus as claimed in claim 1, wherein the electrode comprises a sustain electrode.

8. The plasma display apparatus as claimed in claim 2, wherein the temperature fuse is configured to cut off a flow of an electric current if a temperature of the resistor exceeds about 104° C.

9. A plasma display apparatus, comprising:
a plasma display panel having a plurality of scan electrodes, sustain electrodes and address electrodes;
a selection circuit comprising a first terminal and a second terminal;
a pulse supply unit comprising a first power source configured to provide a first voltage to the first terminal of the selection circuit, a second power source configured to provide a second voltage to the second terminal of the selection circuit, and a thermal fusible resistor between the first terminal of the selection circuit and the first power source; and
a power supply configured to provide power to the pulse supply unit,
wherein the selection circuit is configured to selectively provide a first voltage and a second voltage to one or more of the scan electrodes of the plasma display panel.

10. The plasma display apparatus as claimed in claim 9, wherein the thermal fusible resistor comprises:
a resistor; and
a temperature fuse configured to cut off a flow of an electric current according to a temperature of the resistor.

11. The plasma display apparatus as claimed in claim 9, wherein the pulse supply unit further comprises:
a diode between the thermal fusible resistor and the first power source;
a transistor between the second power source and the second terminal of the selection circuit; and
a capacitor between a common terminal of the thermal fusible resistor and the diode and the second terminal of the selection circuit.

12. The plasma display apparatus as claimed in claim 11, wherein the pulse supply unit further comprises a resistor between the diode and the first power source.

13. The plasma display apparatus as claimed in claim 9, wherein the first voltage and the second voltage comprise a scan pulse.

14. The plasma display apparatus as claimed in claim 10, wherein the temperature fuse is configured to cut off a flow of an electric current if a temperature of the resistor exceeds about 104° C.

15. The plasma display apparatus as claimed in claim 9, further comprising a scan driver coupled to the plurality of scan electrodes, an address driver coupled to the plurality of address electrodes, and a sustain driver coupled to the plurality of sustain electrodes.
